(19) United States
(12) Patent Application Publication
(10) Pub. No.: US 2025/0109633 A1
(43) Pub. Date: Apr. 3, 2025

(54) Motorized Retractable Screen System

(71) Applicant: Four Season Industries, LLC, Canton, GA (US)

(72) Inventors: Derek D. Melnychuk, Canton, GA (US); Virgolino Carrilho, Greer, SC (US); Steven A. Caputo, Ball Ground, GA (US); Craig J. Cochran, Atlanta, GA (US); Dustin F. Coha, Atlanta, GA (US); Kevin B. Green, Smyrna, GA (US); Kirk W. Charles, Austell, GA (US)

(73) Assignee: Four Season Industries, LLC, Canton, GA (US)

(21) Appl. No.: 18/980,742

(22) Filed: Dec. 13, 2024

Related U.S. Application Data
(63) Continuation-in-part of application No. 18/390,875, filed on Dec. 20, 2023.
(60) Provisional application No. 63/433,806, filed on Dec. 20, 2022.
(60) Provisional application No. 63/609,454, filed on Dec. 13, 2023.

(51) Int. Cl. E06B 9/54; E06B 9/52; E06B 9/72

(52) U.S. Cl. CPC E06B 9/54; E06B 9/521; E06B 9/72; E06B 2009/546

(57) ABSTRACT

Corner tensioning and side edge retention systems for a motorized retractable screen system are disclosed. The corner tensioning and side edge retention systems are designed to maintain tension and/or prevent binding of a screen as it is moved between deployed and retracted positions.

### CROSS REFERENCE TO RELATED APPLICATIONS

This application claims priority as (1) a non-provisional to co-pending U.S. Provisional Application Ser. No. 63/609,454 filed Dec. 13, 2023; and (2) as a continuation-in-part to co-pending U.S. application Ser. No. 18/390,875 filed Dec. 20, 2023, which claims priority to U.S. Provisional Application Ser. No. 63/433,806 filed Dec. 20, 2022, each being entitled “Motorized Retractable Screen System,” and the entire contents of each being incorporated herein by reference.

### FIELD

This disclosure relates to the field of retractable screen systems. More particularly, this disclosure relates to a motorized retractable screen system having a corner tensioning assembly and/or side edge retention assembly for maintaining tension of the screen during its movement between the deployed and retracted positions.

### BACKGROUND

Retractable screens are often installed in the openings of framed areas such as doorways, windows, and porched areas. When deployed, the screen acts as a barrier between the inside and outside of the framed area. Current designs use a motor to unwind the screen from a screen axle located at the top of the framed area and rely on gravity to pull the screen downward. However, wind or air pressure differences between the inside and outside of the framed area will often cause binding along the sides and edges of the screen. Binding prevents lowering of the screen while pressure differences exist or otherwise bunches the screen in the system. Wind will also billow material and lift the bottom of the screen when not desired. Further, as these systems rely on gravity to deploy the screens, they systems only allow the screen to be moved up and down. This limits potential installation opportunities or otherwise makes installation more difficult in certain circumstances in which the requirements of the framed area makes it unfeasible to provide for placement of the components of the system necessary for vertical movement of the screen.

What is needed therefore is a retractable screen system that is designed such that the screen may be deployed without relying on gravity and/or a tensioning system for the retractable screen that maintains sufficient tension on the screen during deployment and retraction of the screen within the framed area.

### SUMMARY

The above and other needs are met by a motorized retractable screen system for a framed area including at least a first side, a second side, a first end, and a second end. The system includes: a screen axle configured to be disposed adjacent the first end of the framed area that is operable to be rotated by a motor; at least one spool operatively connected to the screen axle such that the screen axle and the at least one spool are operable to rotate together; a screen including a first end operatively connected to the screen axle, a second end operatively connected to a bottom bar, a first side, and a second side, and wherein at least the first side of the screen is formed of a mesh material with a plurality of openings; a cable including a first end and a second end, wherein the first end is at least partially wound around the at least one spool and the second end is operatively connected to one of the bottom bar and the second of the screen; and a side edge retention system having a track disposed along a length of at least the first side of the framed area and at least a first brush having a first plurality of brush bristles positioned and configured along a length of the track for engaging the plurality of openings of the mesh material of the first side of the screen during operation of the motorized retractable screen system. During the operation of the motorized retractable screen system, the screen axle is operable to be rotated in either a first direction or a second direction by the motor such that the cable is operable to pull the bottom bar of the screen between a deployed position and a retracted position while the plurality of brush bristles of the side edge retention system retain the first side of the screen in the track.

According to certain embodiments, the motorized retractable screen system further includes a corner tensioning system including a tensioning arm having a first end configured to be operatively connected to a corner of the first side of the screen, a second end operatively connected to the bottom bar, and a biasing mechanism for biasing the first end of the tensioning arm laterally outward towards the first side of the screen.

According to some embodiments, the corner of the first side of the screen includes a stirrup configured to receive the first end of the tensioning arm for operatively connecting the first end of the tensioning arm to the corner of the first side of the screen.

According to some embodiments, the second end of the cable is secured adjacent to the second end of the screen such that the first end of the tensioning arm maintains a lateral force on the corner of the first side of the screen while the cable applies an independent downward force to the screen during operation of the motorized retractable screen system.

According to certain embodiments, the side edge retention system includes a second brush containing a second plurality of brush bristles positioned and configured to oppose the first plurality of brush bristles of the first brush for receiving the first side of the screen between the first brush and the second brush for retaining the first side of the screen in the track. In some embodiments, ends of the first plurality of brush bristles are positioned and configured to overlap with ends of the second plurality of brush bristles. Also in some embodiments, the first and second plurality of brush bristles are positioned and configured with respect to the track to be angled towards the first side of the framed area.

According to certain embodiments, the track includes a first end and a second end that is positioned opposite the first end, and wherein the side edge retention system further includes a second brush having a second plurality of brush bristles, and wherein the first brush is secured to the first end of the track and the second brush is secured to the second end of the track such that ends of the first plurality of brush bristles are positioned and configured to overlap with ends of the second plurality of brush bristles for receiving the first side of the screen between the overlapping first and second plurality of brush bristles. In some embodiments, the first end of the track is dimensioned and configured to receive a plurality of first brushes and the second end of the track is dimensioned and configured to receive a plurality of second brushes for forming a plurality of opposing brush pairs.

According to certain embodiments, the first side of the screen includes a reinforced side edge for enhancing engagement between the first plurality of brush bristles and the plurality of openings of the mesh material of the first side of the screen. In some embodiments, the screen includes a stiffening fiber woven through the plurality of openings of the mesh material.

According to another embodiment of the disclosure, a motorized retractable screen system for a framed area including at least a first side, a second side, a first end, and a second end is provided. The system of this embodiment includes: a screen axle configured to be disposed adjacent the first end of the framed area that is operable to be rotated by a motor; at least one spool operatively connected to the screen axle such that the screen axle and the at least one spool are operable to rotate together; a screen including a first end operatively connected to the screen axle, a second end operatively connected to a bottom bar, a first side, and a second side; a cable including a first end and a second end, wherein the first end is at least partially wound around the at least one spool and the second end is operatively connected to the second of the screen; and a corner tensioning system including a tensioning arm having a first end configured to be operatively connected to a corner of the first side of the screen, a second end operatively connected to the bottom bar, and a biasing mechanism for biasing the first end of the tensioning arm laterally outward towards the first side of the screen. During the operation of the motorized retractable screen system, the screen axle is operable to be rotated in either a first direction or a second direction by the motor such that the cable is operable to pull the bottom bar of the screen between a deployed position and a retracted position while the first end of the tensioning arm maintains an independent lateral force on the corner of the first side of the screen.

According to certain embodiments, the corner of the first side of the screen includes a stirrup configured to receive the first end of the tensioning arm for operatively connecting the first end of the tensioning arm to the corner of the first side of the screen. In some embodiments, the stirrup is disposed above a connection point in which the second end of the cable is operatively connected to the second end of the screen and the tensioning arm includes a jogged arm shape such that the first end of the tensioning arm is configured to be disposed in the stirrup while a base portion of the tensioning arm is configured to be substantially laterally aligned with the connection point.

According to certain embodiments, the corner tensioning system further includes a housing configured to be restrained within the bottom bar, the tensioning arm being operatively connected to the housing such that the tensioning arm is opereable to move laterally outward with respect to the housing and the bottom bar. In some embodiments, the corner tensioning system is configured to receive a locking mechanism that engages with the tensioning arm to selectively lock the tensioning arm in place with respect to the housing.

According to certain embodiments, the corner tensioning system includes a spring adjustment mechanism for independently adjusting the compression strength of the biasing mechanism, the spring adjustment mechanism having means for adjusting the compression strength of the biasing mechanism while the biasing mechanism is disposed within the bottom bar.

According to yet another embodiment of the disclosure, a motorized retractable screen system for a framed area including at least a first side, a second side, a first end, and a second end is provided. According to this embodiment, the system includes: a screen axle configured to be disposed adjacent the first end of the framed area that is operable to be rotated by a motor; at least one spool operatively connected to the screen axle such that the screen axle and the at least one spool are operable to rotate together; a screen including a first end operatively connected to the screen axle, a second end operatively connected to a bottom bar, a first side, and a second side, and wherein at least the first side of the screen is formed of a mesh material with a plurality of openings; a cable including a first end and a second end, wherein the first end is at least partially wound around the at least one spool and the second end is operatively connected to one of the bottom bar and the second of the screen; a side edge retention system having a track disposed along a length of at least the first side of the framed area, the track including a first end and a second end that is positioned opposite the first end, the side edge retention system further including a first brush having a first plurality of brush bristles attached to the first end of the track and a second brush having a second plurality of brush bristles attached to the second end of the track for engaging the plurality of openings of the mesh material of the first side of the screen between the first plurality of brush bristles and the second plurality of brush bristles during operation of the motorized retractable screen system; and a corner tensioning system including a tensioning arm having a first end configured to be operatively connected to a corner of the first side of the screen, a second end configured to be operatively connected to the bottom bar, and a biasing mechanism for biasing the first end of the tensioning arm laterally outward towards the first side of the screen. During operation of the motorized retractable screen system, the screen axle is operable to be rotated in either a first direction or a second direction by the motor such that the cable is operable to pull the bottom bar of the screen between a deployed position and a retracted position while the side edge retention system and corner tensioning system maintain tension of the screen.

According to certain embodiments, the second end of the cable is secured adjacent to the second end of the screen such that the first end of the tensioning arm maintains a lateral force on the corner of the first side of the screen while the cable applies an independent downward force to the screen during operation of the motorized retractable screen system.

According to certain embodiments, the first side of the screen includes a reinforced side edge for enhancing engagement between the first and second plurality of brush bristles and the plurality of openings of the mesh material of the first side of the screen.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a motorized retractable screen system installed in a framed area according to one embodiment of the present disclosure.

FIG. 2 depicts the components of the first side of the motorized retractable screen system of FIG. 1 according to one embodiment of the disclosure.

FIG. 3 depicts the components of the first side of a motorized retractable screen system according to another embodiment of the disclosure.

FIG. 4 depicts a perspective view of a corner tensioning system for the motorized retractable screen system of FIG. 3 according to one embodiment of the disclosure.

FIG. 5 depicts an enlarged partial sectional view of a corner tensioning system for the motorized retractable screen system of FIG. 3 with the screen in the fully deployed position according to one embodiment of the disclosure.

FIG. 6 depicts an enlarged partial sectional view of the corner tensioning system of FIG. 5 with the screen in an intermediate retracted position according to one embodiment of the disclosure.

FIG. 7 depicts a side partial sectional view of the corner tensioning system of FIGS. 3-6 with the series of directional forces applied by the tensioning system depicted according to one embodiment of the disclosure.

FIG. 8 depicts a side partial sectional view of the corner tensioning system with the tensioning arm limited in its upward travel according to one embodiment of the disclosure.

FIG. 9 depicts a side partial sectional view of the corner tensioning system with the tensioning arm limited in its downward travel according to one embodiment of the disclosure.

FIG. 10 depicts a side partial sectional view of the corner tensioning system with the tensioning arm having multiple cable attachment positions and an optional aperture at its first end for attaching to the screen according to one embodiment of the disclosure.

FIG. 11 depicts a first side perspective view of a corner tensioning system according to one embodiment of the disclosure.

FIG. 12 depicts a second side perspective view of the corner tensioning system of FIG. 11 according to one embodiment of the disclosure.

FIG. 13 depicts an enlarged partial sectional view of the corner tensioning system of FIGS. 11-12 for a motorized retractable screen system with the screen in an intermediate retracted position according to one embodiment of the disclosure.

FIG. 14 depicts a side partial sectional view of a corner tensioning system for a motorized retractable screen system with the screen in a fully deployed position according to another embodiment of the disclosure.

FIG. 15 depicts a cross-sectional view of the corner tensioning system of FIG. 14 according to one embodiment of the disclosure.

FIG. 16 depicts a first side perspective view of a portion of the corner tensioning system of FIGS. 14-15 having a locking pin for restricting movement of the tensioning arm according to one embodiment of the disclosure.

FIG. 17 depicts a cross-sectional view of a corner tensioning system having an adjustable tensioning force according to one embodiment of the disclosure

FIG. 18 depicts a cross-sectional view of a corner tensioning system having an adjustable tensioning force according to another embodiment of the disclosure

FIG. 19 depicts an overhead perspective view of a side edge retention system for a motorized retractable screen system according to one embodiment of the disclosure.

FIG. 20 depicts an overhead perspective view of the brush bristles of one end of the side edge retention system of FIG. 19 engaging a first side of a motorized retractable screen according to one embodiment of the disclosure.

FIG. 21 depicts an overhead view of the side edge retention system of FIG. 19 according to one embodiment of the disclosure.

FIG. 22 depicts a front view of a motorized retractable screen system having a screen with a reinforcing fiber woven through mesh openings along the length of the screen for forming a screen having a reinforced side edge according to one embodiment of the disclosure.

FIG. 23 depicts a front perspective view of an adjustable cable tensioning assembly according to one embodiment of the disclosure.

FIG. 24 depicts a side view of the adjustable cable tensioning assembly of FIG. 23 with an uncompressed tensioning spring according to one embodiment of the disclosure.

FIG. 25 depicts a side view of the adjustable cable tensioning assembly of FIG. 23 with a compressed tensioning spring according to one embodiment of the disclosure.

FIG. 26 depicts a bottom pulley positioning adjustment system according to one embodiment of the disclosure.

### DETAILED DESCRIPTION

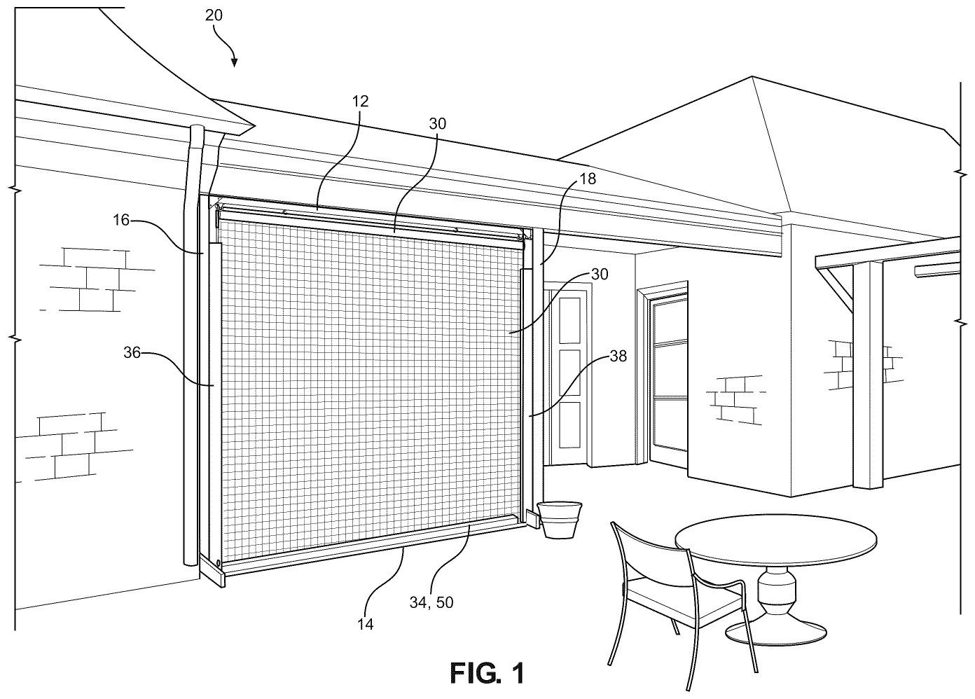

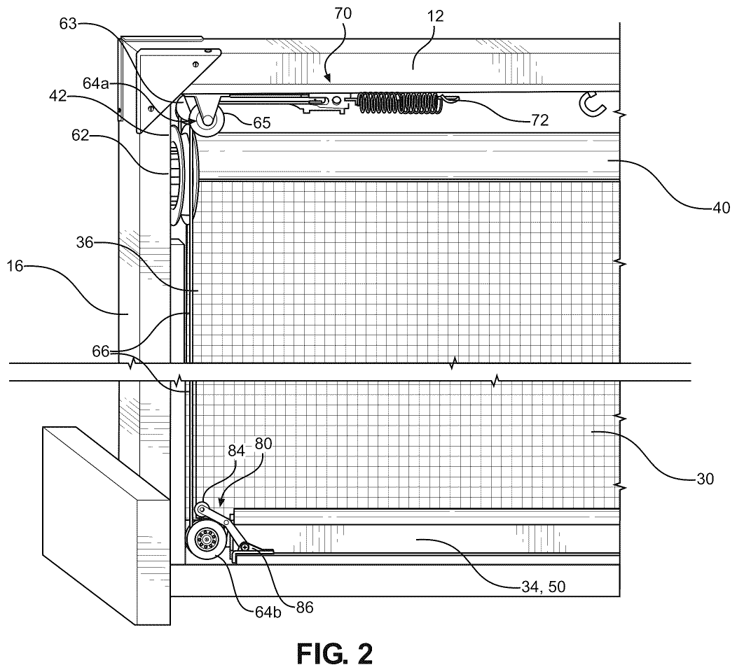

With reference to FIGS. 1-2, a motorized retractable screen system 20 according to one embodiment of the present disclosure is depicted. In operation, the screen system 20 moves a screen 30 between a deployed position and a retracted position within a framed area. For purpsoses of the present disclosure, a “screen” is intended to broadly encompass any type of movable partition made from any number of different materials such as mesh insect screens, shade screens, privacy screens, clear vinyl screens, television projector screens, etc. The framed area in which the screen system 20 is installed is preferably a porched or outdoor patio area but may also include countless other open areas such as doorways, windows, garages, a wall portion in which a tv projection screen is intended to be deployed, etc.

With reference specifically to FIG. 1, the framed area generally includes a first end 12 (e.g., top end in FIG. 1), a second end 14 opposite the first end 12 (e.g., bottom end in FIG. 1), a first side 16 (e.g., left side in FIG. 1), and a second side 18 (e.g., right side in FIG. 1). In certain embodiments, the framed area is specifically designed for installation of the retractable screen system 20. In other embodiments, certain portions of the framed area may be formed from existing structures such as walls, ceilings, columns, floors, decking, etc. Similar to the framed area, the screen 30 also includes a corresponding first end 32, a second end 34, a first side 36, and a second side 38. The screen 30 is dimensioned and configured to cover the opening of the framed area in the deployed position and provide access to the opening of the framed area in the retracted position. In preferred embodiments, the motorized screen system 20 is operable to selectively position the screen 30 anywhere between the deployed position and the retracted position.

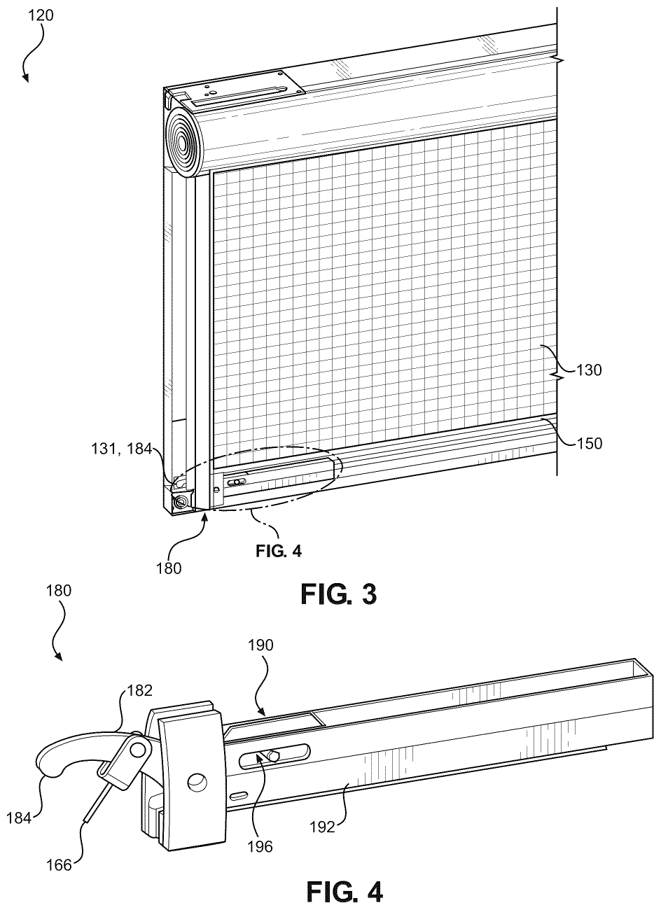

With reference to FIG. 2, the first end 32 of the screen 30 is connected to a screen axle 40 positioned adjacent the first end 22 of the framed area. The second end 34 of the screen 30 is secured to a weighted bottom bar 50. The motorized retractable screen system 20 of this embodiment further includes a drive system that generally includes a motor 62, a cable and pulley system, and a track system in which the screen 30 travels. More specifically, according to the embodiment shown, the drive system includes a motor 62 configured to drive/rotate the screen axle 40. A spool 42 is operatively connected to each side of the screen axle 40 such that the screen axle 40 and the spools 42 are configured to rotate together when driven by the motor 62. The cable and pulley system operates to drive the screen 30 and bottom bar 50 along a track (not shown) disposed at the sides 16, 18 of the framed area when the spools 42 are rotated. In this regard, adjacent each of the first side 16 and second side 18 of the framed area (the first side 16 being shown in FIG. 2), the first end of a cable 66 is operatively connected to the spool 42. The cable 66 is then wound at least partially around the spool 42 (in the opposite direction in which the screen is intended to be wound around the screen axle 40) and through a series of pulleys 64 with the second end of the cable 66 then operatively connected to one of the bottom bar 50 and the second end 34 of the screen 30. As a result, a closed loop system is formed preferably on both sides of the screen 30 with (1) the first end of the cable 66 being operatively connected to the spool 42; (2) the second end of the cable 66 being operatively connected to one of the bottom bar 50 (which is operatively connected to the second end 34 of the screen 30 as noted above) and the second end 34 of the screen 30; (3) the first end 32 of the screen 30 being operatively connected to the screen axle 40; and (4) the screen axle 40 and spool 42 being operatively connected such that rotation of the screen axle 40 also rotates the spool 42. For purposes of the present disclosure, “operatively connected” could refer to a direct connection (e.g., the spool 42 connected directly to the screen axle 40) or to an indirect connection via one or more intermediate parts (e.g., the second end of the cable 66 is connected to the bottom bar 50 or the second end 34 of the screen 30 via a tensioner arm as explained further below with respect to the embodiments of FIGS. 3-13).

In operation, the motor 62 operates to rotate the screen axle 40 and corresponding spools 42 in either a first direction or a second direction. Force is translated from the torque of the motor to the bottom bar 50 and/or the second end 34 of the screen 30 to pull the screen 30 in a desired direction along the tracks. When rotated in the first direction, the cables 66 are wound around the spools 42 (i.e., the length of the cables 66 is shortened) such that the cables 66 pull the bottom bar 50 and/or the second end 34 of the screen 34 towards the deployed position while the screen 30 is being unwound from the screen axle 40. In the second direction, the cables 66 are being unwound from the spools 42 (i.e., the length of the cables 66 is increased) such that the cables 66 pull the bottom bar 50 and/or the second end 34 of the screen 30 towards the retracted position while the screen 30 is being wound back around the screen axle 40.

With continued reference to FIG. 2, the drive system 60 is designed to maintain tension to the cables 66 and the screen 30 during movement between the retracted and deployed positions. In this regard, the drive system 60 preferable utilizes, on each side of the screen 30, a first pulley system 64a located adjacent to the spool 42 at the first end 12 of the framed area and then a corresponding second pulley system 64b located at the second end 14 of the framed area. The spools 42, first pulley system 64a, and second pulley system 64b operate to create a tension field along the sides 36, 38 of the screen 30 that is directly proportional to the tension in the cables 66.

According to another aspect of the disclosure, and with continued reference to FIG. 2, the first pulley system 64a for each cable 66 may further include a tensioning system for further assisting in maintaining tension of the cable 66 (and therefore maintaining tension in the screen 30). According to this embodiment, the first pulley system 64a includes a first pulley 63 and second pulley 65 positioned along the first end 12 of the framed area. The cable 66 extends from the spool 42 around the first pulley 63 to a tensioning spring system 70 and then back through the second pulley 65. From the second pulley 65 of the first pulley system 64a, the cable 66 then extends along the respective side 16, 18 of the framed area and around the second pulley system 64b to be connected to the bottom bar 50 or the second end 34 of the screen 30. Tensioning spring system 70 helps to maintain tension to the cable 66 where the tension in the cable is determined by the force of the tensioning spring 72 of the tensioning spring system 70. The tensioning spring system 72 could be an extension spring, a compression spring, torsion spring and accommodating swingarm-mounted pulley, or any other spring known in the art that is able to maintain tension on the cable 66. The tensioning spring system 70 is intended to benefit from selection of a generally low rate spring 72 so that force does not vary significantly throughout movement of the screen 30. The positioning of the tensioning spring system 70 (or components thereof) may also be adjustable with respect to the frame to modify tensioning charactistics as needed (such as during installation or maintenance).

With respect to the tensioning spring system 70, the diameter of the spools 42 are preferably of a similar diameter to that of the screen axle 40. This helps to ensure that the tension of the spring 72 does not vary significantly over the range of travel of the screen 30, and therefore the tension of the cable 66 also does not vary significantly. It is also noted that the diameter of the spools 42 and screen axle 40 change slightly during operation of the system 20 as a result of the screen 30 being wound/unwound from the screen axle 40 and the cable 66 being unwound/wound from the corresponding spools 42. This may be accounted for in varying ways including the selection of particular thicknesses of the screen 30 and cable 66 to help ensure the force of the spring 72 of the tensioning spring system 70 does not vary significantly during the movement of the screen 30. In particular, according to certain embodiments, the thickness of the screen 30 and cable 66 may be selected so that the necessary spring tension of spring 72 is at a maximum when the screen 30 is fully deployed.

According to another aspect of the disclosure, and with reference initially to FIG. 2, the drive system 60 preferably includes a corner tensioning system 80 for maintaining tension on the screen 30 by maintaining a downward and outward force on both sides of the screen 30 (i.e., both sides of the screen 30 include separate corner tensioning systems 80). For purposes of the present disclosure, “downward” refers to a direction towards the second end 14 of the framed area and/or second end 34 of the screen though it should be understood that the actual direction may not be vertically downward such as when the screen 30 is intended to move horizontally within the framed area instead of vertically. According to this embodiment, the corner tensioning system 80 includes a tensioning arm 82 having a first end 84 and a second end 86. The first end 84 of the tensioning arm 82 is operatively connected to the screen 30 adjacent one of the corners of the second end 34 of the screen 30. The second end 86 of the tensioning arm 82 is then operatively connected to the bottom bar 50. The cable 66 that extends from the second pulley system 64b is then operatively connected to the tensioning arm 82 to connect the cable 66 to the screen 30/bottom bar 50 via the tensioning arm 82. As shown, the cable 66 is preferably connected to the tensioning arm 82 between the connection points of the first end 84 to the screen 30 and the second end 86 to the bottom bar 50. Further, in preferred embodiments and as shown in FIG. 2, the connection point of the first end 84 with the screen 30 is generally positioned in alignment with the second pulley system 64b (i.e. vertical alignment when the screen 30 is intended to move up/down or horizontal alignment when the screen 30 is intended to move in a horizontal direction). With the bottom bar 50 then extending somewhat below the second end 34 of the screen 30, the tensioning arm 82 preferably provides an oblique angle between the connection point with the screen 30 and the connection point with the bottom bar 50. This oblique angle between the connection points enhances the downward and outward force on the screen 30 created by the corner tensioning systems 80.

With reference to FIGS. 3-10, another embodiment of a corner tensioning system 180 for a motorized retractable screen system 120 is depicted. Similar to the embodiment of FIG. 2, the corner tensioning system 180 includes a tensioning arm 182 having a first end 184 and a second end 186. Cable 166 is operatively connected to the tensioning arm 182 between the first end 184 and the second end 186. According to this embodiment, the first end 184 is operatively connected to the screen 130 via being inserted into a stirrup 131 positioned at the lower corner of the screen 130 (e.g., a pocket sewn into the corner of the screen 130). However, any number of potential connections of the first end 184 to the screen 130 are also possible such as with rivets, fasteners, etc.

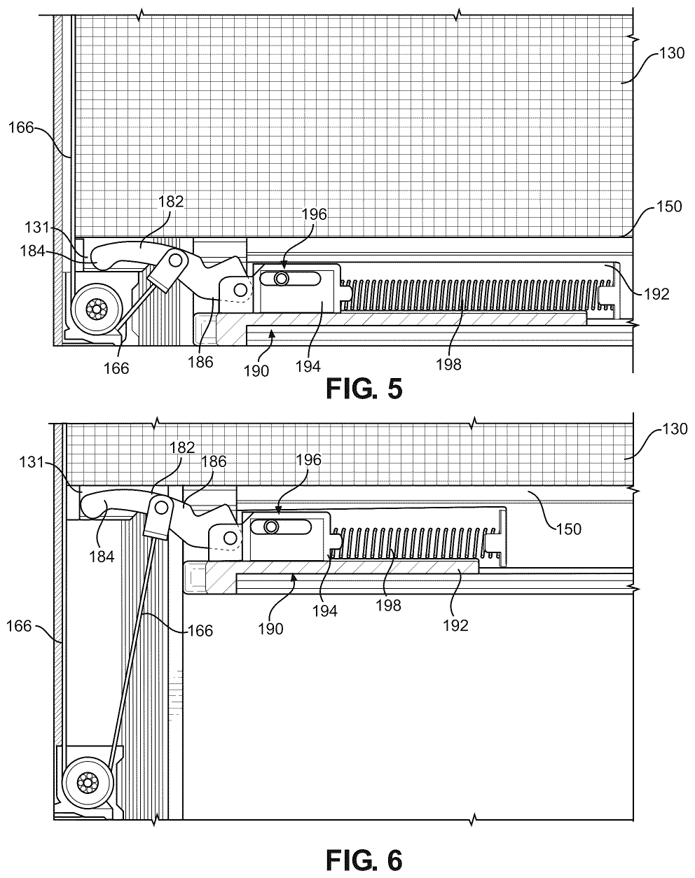

As shown best in FIG. 5-6, second end 186 of tensioning arm 182 is operatively connected to a tensioning assembly 190 disposed within bottom bar 150. The tensioning assembly 190 is operable to provide a biased outward force to the second end 186 of the tensioning arm 182. While various forms of the tensioning assembly 190 are possible and intended to be within the scope of the present disclosure, tensioning assembly 190 of the embodiment shown includes a housing 192 secured within the bottom bar 150. A carriage 194 is disposed within the housing 192 such that it is operable to move laterally with respect to the bottom bar 150 and housing 192. In preferred embodiments, the carriage 194 is connected to the housing 192 such that it is able to slide within the limits of a pin and slot arrangement 196. The second end 186 of the tensioning arm is operatively connected to a first end of the carriage 194. A biasing means 198 (e.g., low rate compression spring) is then operatively connected to the second end of the carriage 194 to provide the biased outward force to the second end 186 of the tensioning arm 182.

With continued reference to FIG. 5 (which depicts the positioning of the bottom bar 150/screen 130 at the second end of the framed area) and FIG. 6 (which depicts the positioning of the bottom bar 150/screen 130 in an intermediate retracted position as compared to FIG. 6), the cable 166 is preferably pivotally connected to the tensioning arm 182 such as with a clevis connection. This allows the angle of the cable 166 to be changed depending on the position of the bottom bar 150 with respect to the framed area and/or on the outward movement of the carriage 194 with respect to the bottom bar 150. Similarly, the stirrup 131 is preferably dimensioned and configured to allow small lateral movements or pivots of the first end 184 of the tensioning arm 182 while the second end 186 of the tensioning arm 182 is pivotally connected to the carriage 194 of the tensioning assembly 190.

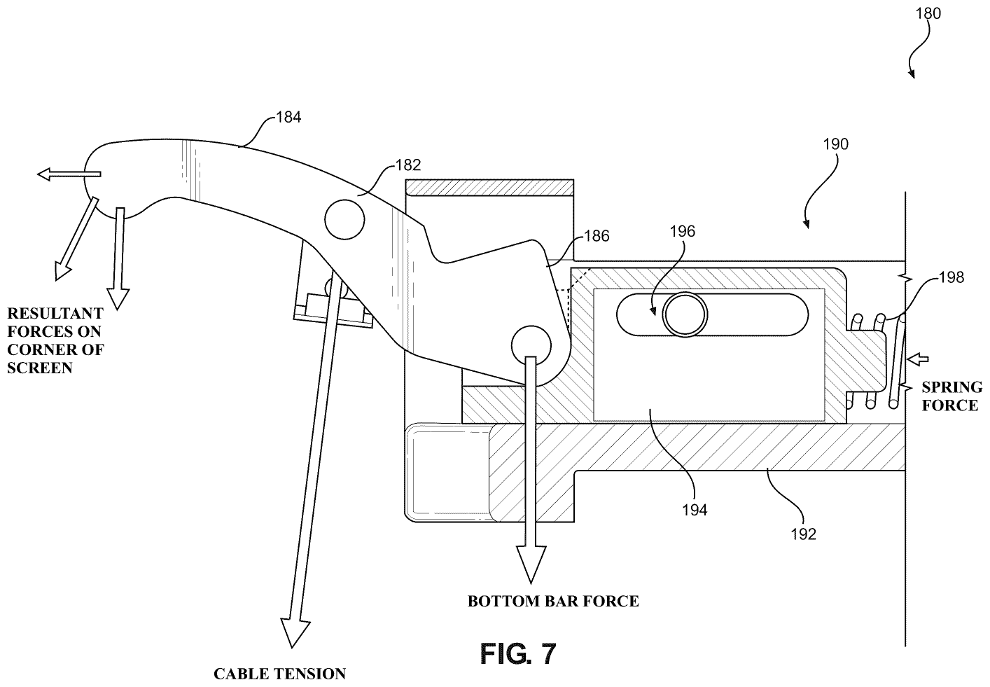

With reference to FIG. 7, corner tensioning system 180 maintains tension of the screen by providing a series of downward (assuming screen 130 is configured to move vertically within the framed area) and outward forces in the direction of the corresponding corner of the second end 24 of the framed area as depicted.

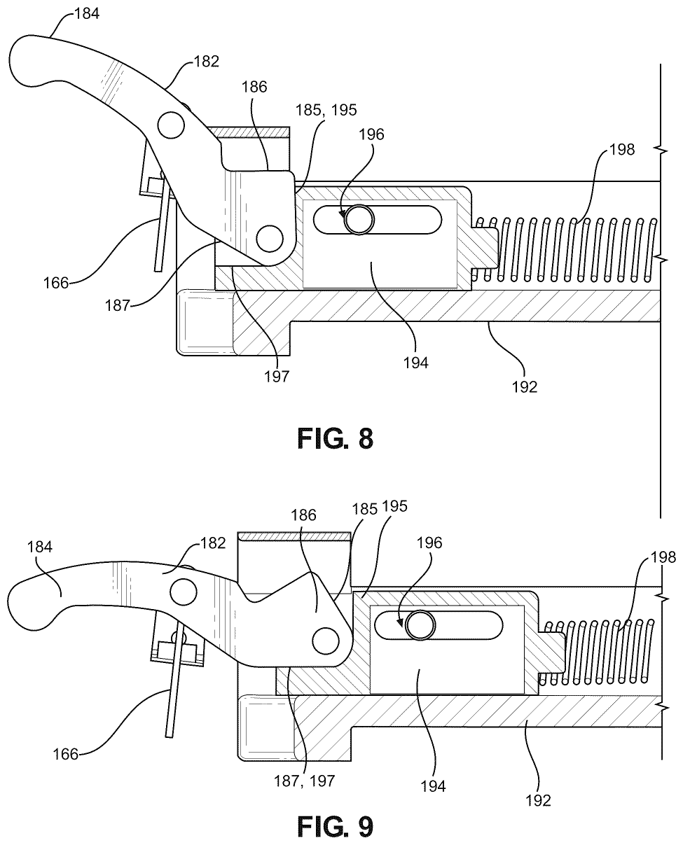

With reference to FIGS. 8 and 9, the second end 186 of the tensioning arm 182 and the corresponding end of the carriage 194 to which the tensioning arm is connected are preferably dimensioned and configured to limit upward and/or downward movement of the tensioning arm 182. According to this embodiment, the second end 186 of the tensioning arm includes a first stop edge 185 and second stop edge 187. The carriage 194 similarly includes a corresponding first stop edge 195 and second stop edge 197. The second end of the tensioning arm 182 is then pivotally connected to the carriage 194 such that the first stop edge 185 of the tensioning arm 182 engages the first stop edge 195 of the carriage 194 to limit movement of the tensioning arm 182 in a first rotational direction and the second stop edge 187 of the tensioning arm 182 engages the second stop edge 197 of the carriage to limit movement of the tensioning arm 182 in a second rotational direction.

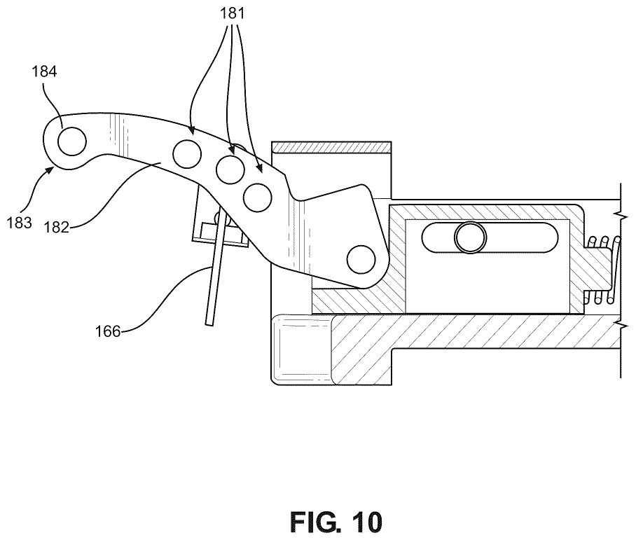

With reference to FIG. 10, the tensioning arm 182 may include a plurality of attachment positions 181 for altering the position of the attachment point between the cable 166 and the tensioning arm 182. The plurality of attachment positions 181 are available to easily and quickly change the proportion of downward-to-outward resultant force on the corner of the screen 130 without replacing the tensioning arm 182 or making changes to the tensioning assembly 190. FIG. 10 also shows an optional aperture 183 at the first end of the tensioning arm 182 for operatively connecting the tensioning arm to a corresponding aperture on the screen 130 with a grommet and associated hardware (e.g., screw, rivet, etc.).

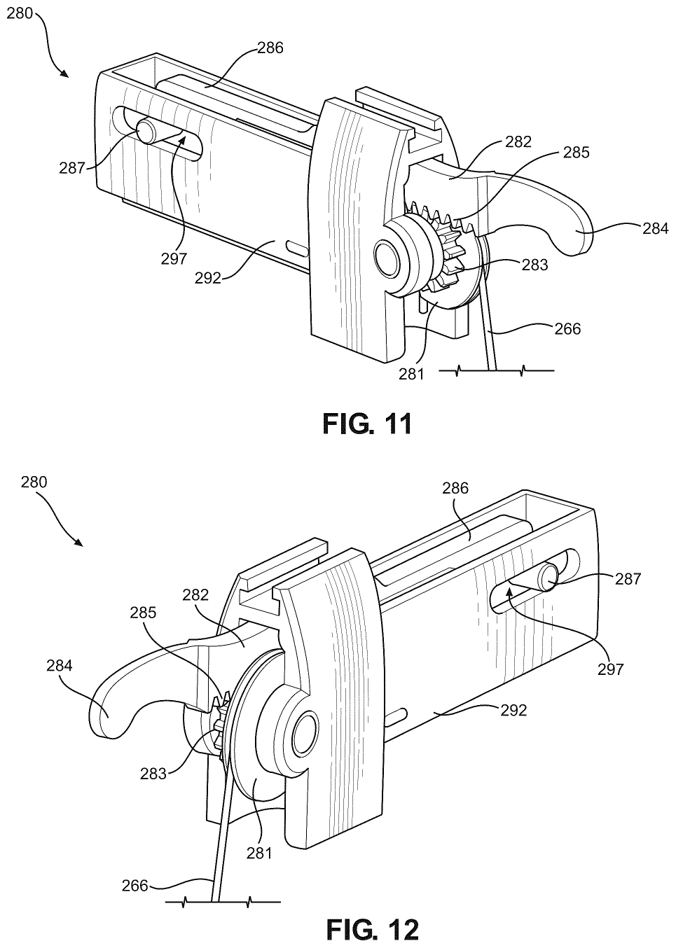

According to another embodiment of the disclosure, and with reference to FIGS. 11-13, corner tensioning system 280 of this embodiment includes a tensioning arm 282 that is configured to move laterally within housing 292 that is disposed within the bottom bar 250. According to this embodiment, the first end 284 of the tensioning arm 282 is operatively connected to the screen 230 as described above (e.g., within a stirrup 231 disposed at the corner of screen 230 as shown in the exemplary embodiment of FIG. 12). The second end 286 of the tensioning arm 282 is secured to the housing 292 such that the tensioning arm 282 is operable to move laterally with respect to the bottom bar 250. For example, in the embodiment shown, the second end 286 of the tensioning arm includes a pin 287 configured to slide within a slot 297 of the housing 292 with the amount of potential movement of the tensioning arm 282 being defined by the length of the slot 297.

In this embodiment, instead of being connected directly to the tensioning arm 282, the cable 266 is operatively connected to the tensioning arm 282 via a roller spool 281 that is connected to the housing 292. More specifically, the cable 266 extends from pulley 264 and is partially wrapped around and then connected to the roller spool 281. The roller spool 281 and tensioning arm 282 are positioned and configured with respect to the housing 292 such that gear teeth 283 of the roller spool 281 mesh with corresponding gear teeth 285 of the tensioning arm 282. In operation, the tension of the cable 266 creates torque on the roller spool 281. The torque on the roller spool 281 creates a rack-and-pinion action between the circular gear teeth 283 of the roller spool 281 and the linear gear teeth 285 of the tensioning arm 282. In other words, the torque applied to the roller spool 281 by the cable 266 results in lateral motion of the tensioning arm 282 such that the tensioning arm 282 is actively biased outward to maintain corresponding outward tension on the screen 230.

According to another aspect of this embodiment, the diameter of the spool 281 can be varied during installation and/or maintenance with larger diameter spools creating more outward push on the tensioning arm 282.

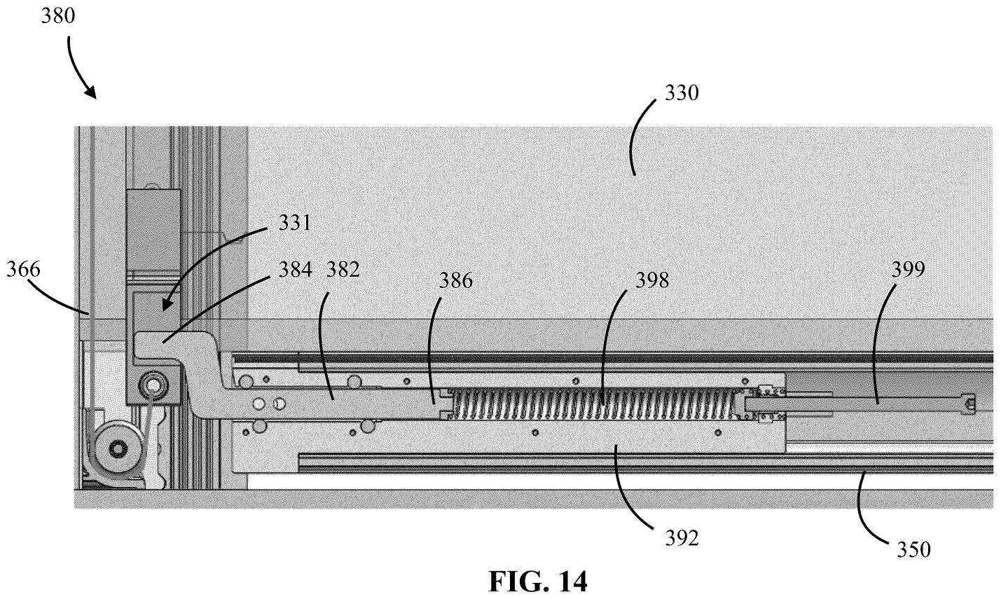

According to another embodiment of the disclosure, and with reference to FIGS. 14-18, corner tensioning system 380 includes a tensioning arm 382 dimensioned and configured to move laterally within a housing 392 that is disposed within the bottom bar 350 (similar to the embodiment of FIGS. 11-13). According to this embodiment, the second end of the cable 366 is secured directly to the screen 330 adjacent the second end 334. Thus, corner tensioning system 380 is designed to maintain an outward/lateral force on the screen 330 while the cable 366 applies an independent downward force to the screen 330.

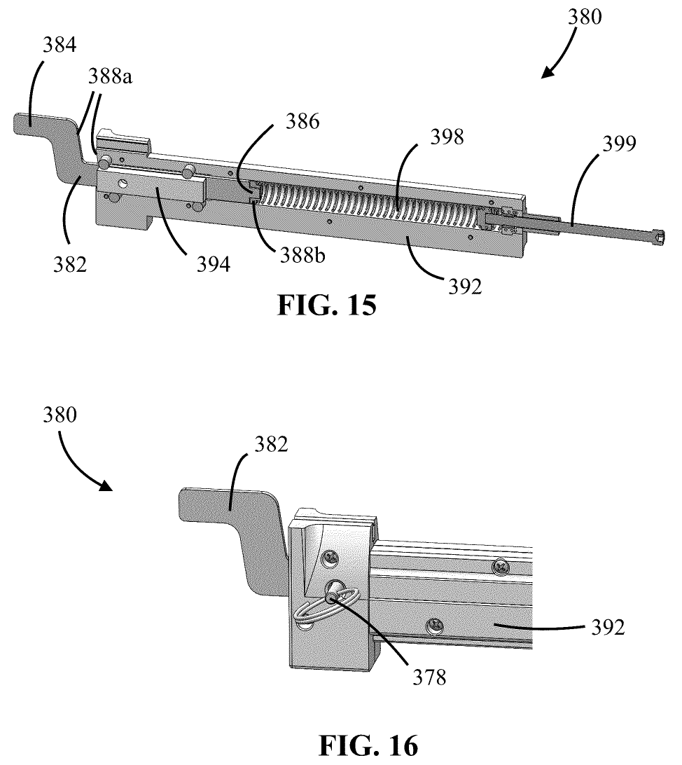

More specifically, as shown best in the exemplary embodiment of FIG. 14, the tensioning arm 382 is movably secured within housing 392 such that the tensioning arm 382 is operable to move laterally with respect to the housing 392 and bottom bar 350. For example, as depicted best in FIG. 15, low friction guide elements 394 are placed within the housing 392 on opposite sides of the tensioning arm 382 for allowing smooth movement and minimized energy loss during the laterally constrained movement of the tensioning arm 382 within housing 392. With continued reference to FIG. 15, the housing 392 and/or tensioning arm 382 are configured to provide physical stops 388a and 388b for limiting the range of travel of the tensioning arm 382 within the housing 392. The physical stops could be based simply on the configurations of the tensioning arm 382 and housing 392 (i.e., stops 388a) and/or be incorporated into the slot of housing 392 in which the tensioning arm 382 is intended to move (i.e., stops 388b). With reference to FIG. 16, a locking mechanism 378 may also be provided to fully restrict the movement of the tensioning arm 382 within the housing 392 when desired (e.g., during installation or maintenance of the system).

With reference back to FIG. 14, the first end 384 of the tensioning arm 382 is configured to be operatively connected to the screen 330 by being positioned into a stirrup 331 disposed at the bottom corner of screen 330. As shown, the stirrup 331 is sized and dimensioned to allow for movement of the first end 384 of the tensioning arm 382 within the stirrup 331 so that the tensioning arm 382 is able to provide an adjustable horizontal force on the screen 330 during use/movement of the screen 330. The second end 386 of the tensioning arm 382 is operatively connected to a spring/biasing mechanism 398 for biasing the tensioning arm 382 outward towards the side of the screen 330. As shown, the biasing mechanism 398 is preferably disposed within the housing 392. However, the biasing mechanism 398 could also potentially be incorporated into the bottom bar 350 such that the second end 386 of the tensioning arm 382 is operatively connected to the biasing mechanism 398 when the housing 392 is operatively connected to the bottom bar 350.

In certain embodiments, and as depicted in FIGS. 14-18, the tensioning arm 382 includes a “jogged arm” shape with the first end 384 disposed laterally above the second end 386. Thus, as shown best in FIG. 14, the first end 384 is able to be positioned in a stirrup 331 that is disposed above the connection point between the screen 330 and the cable 366. The tensioning arm 382 then transitions downward adjacent the first end 384 to provide a base/pusher portion having the second end 386 that is substantially laterally aligned with the connection point between the screen 330 and the cable 366. This jogged-shape for the tensioning arm 382 and its placement of its first end 384 and base/pusher portion with respect to the connection point between the screen 330 and cable 366 applies an optimal lateral force against the bottom corner portion of the screen 330.

In preferred embodiments, the biasing mechanism 398 is operable to be independently adjustable to accommodate stretchability of different screen materials and changes to the stretchability of the screen 330 during its useful life. For example, with reference to FIG. 15, a spring adjustment mechanism 399 may be operatively connected to the biasing mechanism 398 at the end of the biasing mechanism opposite the second end 386 of the tensioning arm 382 for increasing/decreasing the spring compression of the biasing mechanism 398 as desired during installation and/or maintenance.

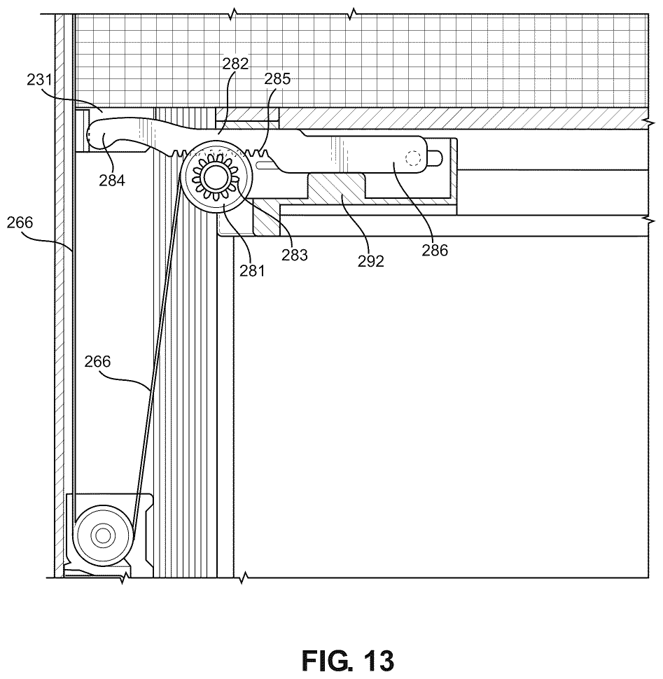

In certain embodiments, the spring adjustment mechanism 399 is configured to adjust the compression force of the biasing mechanism 398 from outside the bottom bar 350. In other words, the spring force of the biasing mechanism 398 is preferably able to adjusted without having to remove the corner tensioning system 380 from the bottom bar 350 and/or without having to remove the first end 384 of the tensioning arm 382 from the stirrup 331 of the screen 330. It should be understood that the spring adjustment mechanism 399 may be adjusted from outside the bottom bar 350 in different manners. For example, with reference to FIGS. 13 and 14, the adjustment mechanism 399 of this embodiment is in the form of a plunger type pusher bar that could be positioned and configured within the bottom bar 350 such that a tool could be inserted into the bottom bar for moving the plunger in a desired direction for adjusting the compression force of the biasing mechanism 399.

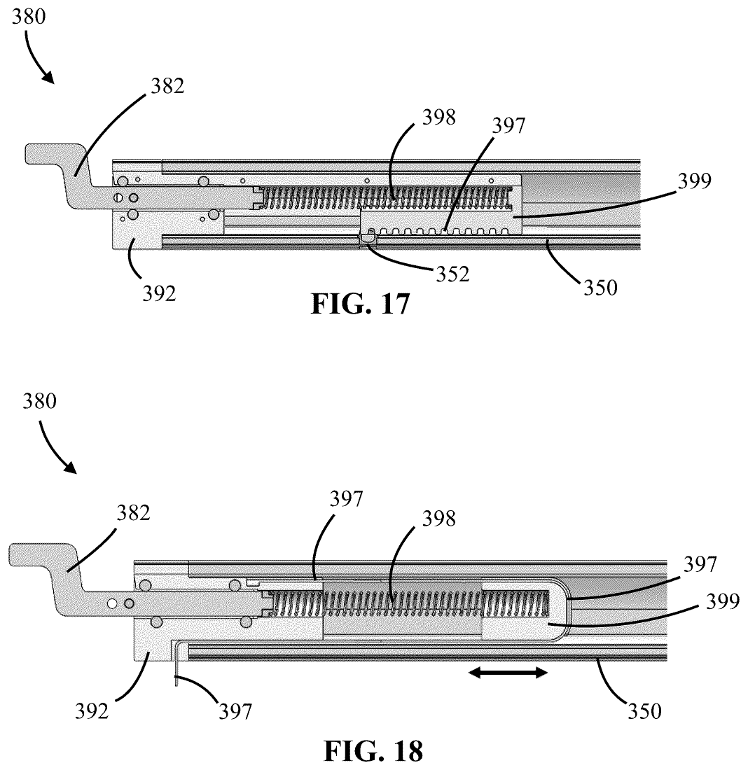

Similarly, with respect to FIG. 17, the spring adjustment mechanism 399 is in the form of a rear housing operatively connected to the biasing mechanism 398. The rear housing includes a ratcheting mechanism 397 that is operatively connected to a corresponding ratcheting mechanism 352 of the bottom bar 350. For example, as depicted in FIG. 17, ratcheting mechanism 397 of the rear housing may include a plurality of gear teeth disposed along the length of the rear housing while the ratcheting mechanism 352 of the bottom bar 350 is a rotary gear operatively accessible from the outside of the bottom bar 350. In operation, rotation of the rotary gear of the bottom bar 350 operates to linearly move the rear housing of the corner tensioning system 380 for desired adjustment of the biasing mechanism 398 depending on the particular direction of the rotation of the rotary gear.

With respect to FIG. 18, the spring adjustment mechanism 399 of this embodiment includes a rear housing positioned around or against the rear end of the biasing mechanism 398. A cable tie 397 or similar mechanism with a first end disposed outside the bottom bar 350 is then operatively wound/looped around a portion of housing 392 containing the tensioning arm 382 and the spring adjustment mechanism 399. Thus, pulling on or releasing the cable tie 397 is configured to move the spring adjustment mechanism 399 with respect to the biasing mechanism 398 for adjusting the compression force of the biasing mechanism 398.

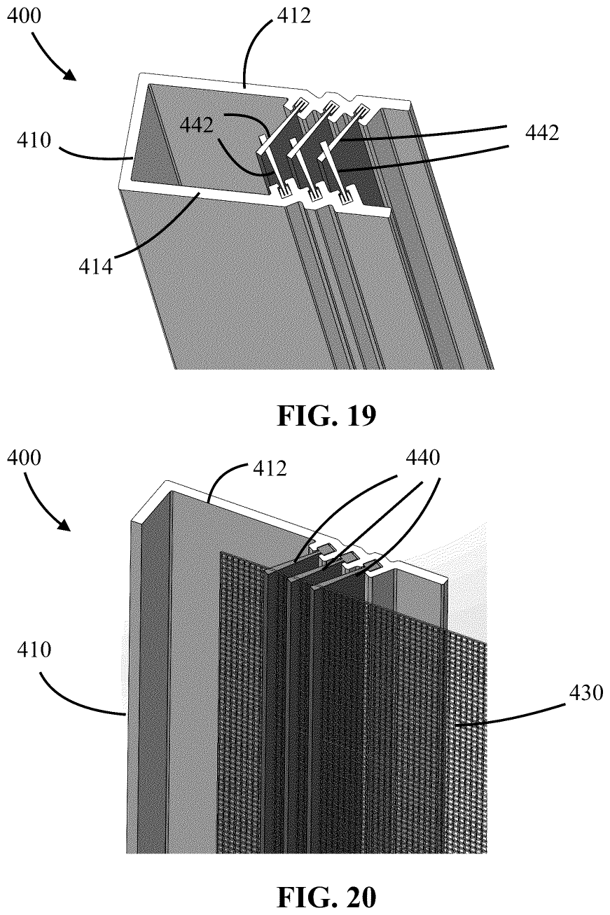

According to another aspect of the disclosure, and with reference to FIGS. 19-21, an exemplary side edge retention system 400 for incorporation into a closed-loop type motorized cable screen system as described herein (such as shown and described herein with respect to FIGS. 1 and 2) is depicted. The side edge retention system 400 generally includes a track 410 for receiving and retaining a first side of the screen 430 as the screen moves between the deployed and retracted positions. As should be understood, and with reference back to FIG. 2, the track 410 is intended to be positioned along the first side 16 of the framed area between the first end 12 and the second end 14. While FIGS. 19-21 depict a side edge retention system 400 for engagement with a first side of screen 430, it should be understood that a corresponding side edge retention system may also be utilized for the opposite second side of screen 430. The side edge retention system 400 of this embodiment further includes brushes 440 retained along the length of the track 410 with each of the brushes containing brush bristles (e.g., commercially available brush strips) for engaging the openings of a mesh screen 430 (or a screen 430 otherwise having mesh disposed along the lengths of the sides of the screen 430) as the screen 430 moves along the track 410 (as depicted in FIG. 20).

The insertion of the bristles of the brushes 440 within the openings of the mesh material of the screen 430 prevents the sides of the screen 430 from pulling out of the track 410, such as when the screen 430 is subject to high winds and mechanical loads. The combination of (1) the present closed-loop type cable system for driving a mesh screen 430 between both the deployed and retracted positions; and (2) incorporating brush bristles along the side tracks 410 for retaining the mesh screen 430 within the tracks 410 has been found to be particularly optimized for maintaining tension of the screen and preventing screen binding during use and operation of the system. The corner tensioning systems as described herein further optimizes the system in maintaining tension of the screen. It is further noted that the combination of features of the present system provide self-aligning of the sides of the screen within the brush bristles of the tracks. In other words, during movement of the screen, the tension created on the sides of the screen results in the sides of the screen self-aligning within the brush bristles of the tracks. Similarly, if a portion of a side of the screen somehow becomes disengaged from the brush bristles of the tracks at any point, movement of the screen will result in the removed portion becoming quickly renengaged with the brush bristles.

According to certain embodiments, and with reference to FIG. 19, track 410 is configured to receive one or more opposing brush pairs 442. Each pair 442 is designed such that the ends of the bristles of the brushes 440 are preferably positioned to overlap at least partially for retaining the screen 430 between the bristles of the opposing brush pairs 442. For example, track 410 of FIG. 19 includes a first end 412 and a second end 414 that is positioned opposite the first end 412. A first brush 440 containing bristles is secured to the first end 412 while an opposing second brush 440 containing bristles is secured to the second end 414 to form an opposing brush pair 442 such that the bristles from the opposing brushes at least partially overlap as depicted in FIG. 19. The bristles of the opposing brush pairs 442 extend through the openings of the mesh screen 430 for maintaining retention of the screen 430 within the track 410. During operation, the sides of the screen 430 find an equilibrium position between the brushes based on the tension in the screen created by the edge retention system and/or corner tensioning system as described herein.

In certain embodiments, and as depicted in FIG. 19, track 410 is in the form of a custom extruded U-shaped piece of plastic that is configured to be secured to the side of the framed area. The U-shaped opening faces towards the inside of the framed area to form the first end 412 and opposing second end 414. As also shown, the custom extrusion is configured to allow for the insertion of one or more pairs of brushes 440 (in the form of brush insert strips) along the inside walls of the first end 412 and second end 414 such that the brushes extend along the length of the track 410. However, any number of materials and configurations for the track 410 and brushes 440 are possible and intended within the scope of the disclosure.

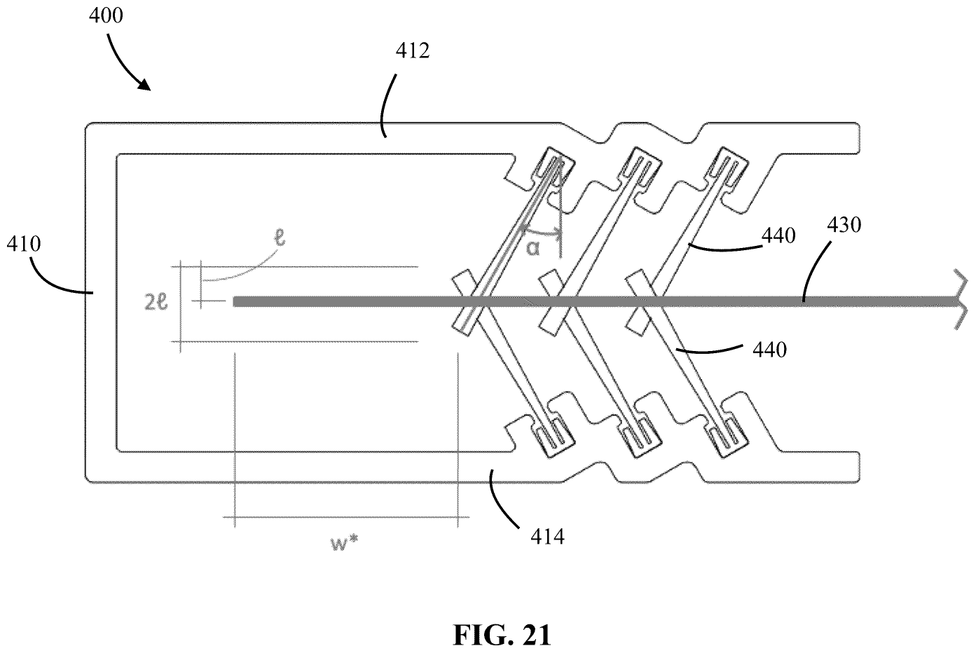

With reference to FIG. 21, and while the bristles of the opposing brush pairs 442 may take many different configurations with respect to the track within the scope of the present disclosure, the angle of the bristles are preferably angled towards the outer side edges of the screen 430. In certain embodiments, the angle “α” is between 10° and 60°, and most preferably about 45°. Other dimensions of the bristles as compared to the screen 430 include an overlap “ [symbol] ” from about 0 to 0.25 inches while the mesh extends past the most outboard opposing brush bristle pair (“w”) at least about 0.25 inches or the equivalent of about 3-10 mesh opening pitches.

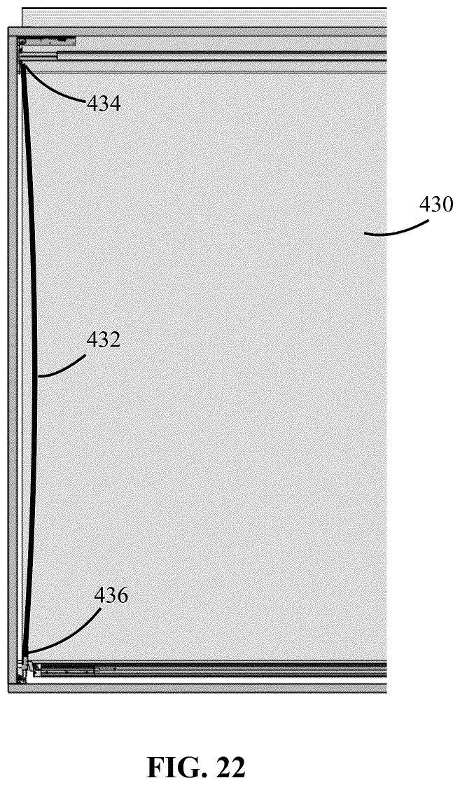

According to certain embodiments, screen includes reinforced side edges that are configured to be stiffer than the rest of the screen. Different ways to include the reinforced edge are possible and within the scope of the disclosure, including using heat stiffening techniques, adding an additional sewn-in monofilament polyester layer to side edges of an existing mesh screen, etc. In one exemplary embodiment, and with reference to FIG. 22, screen 430 includes a stiffening fiber 432 (e.g., monofilament fiber such as used for fishing lines) that is secured to the screen by weaving the fiber through various openings in the sides of the screen according to a desired pattern. In preferred embodiments, the fiber 432 is woven into the screen 430 according to a catenary shape as depicted in FIG. 22. The first end 434 of the fiber 432 is connected to the spool adjacent the first end of the framed area while the second end 436 of the fiber is connected to the second end of the screen 430 or otherwise adjacent the connection point between the cable and the second end of the screen. Accordingly, the fiber 432 maintains tension as it winds/unwinds with the screen 430. In operation, the tension of the fiber creates an outward tension and increased stiffness to the side of the screen 430. The increased tension and stiffness of the reinforced side edges of the screen 430 are particularly advantageous when used with a side edge retention system 400 as described above having opposing brush pairs 442. In this regard, the increased stiffness of the openings along the side of the mesh screen 430 provide enhanced retention of the bristles during movement of the screen.

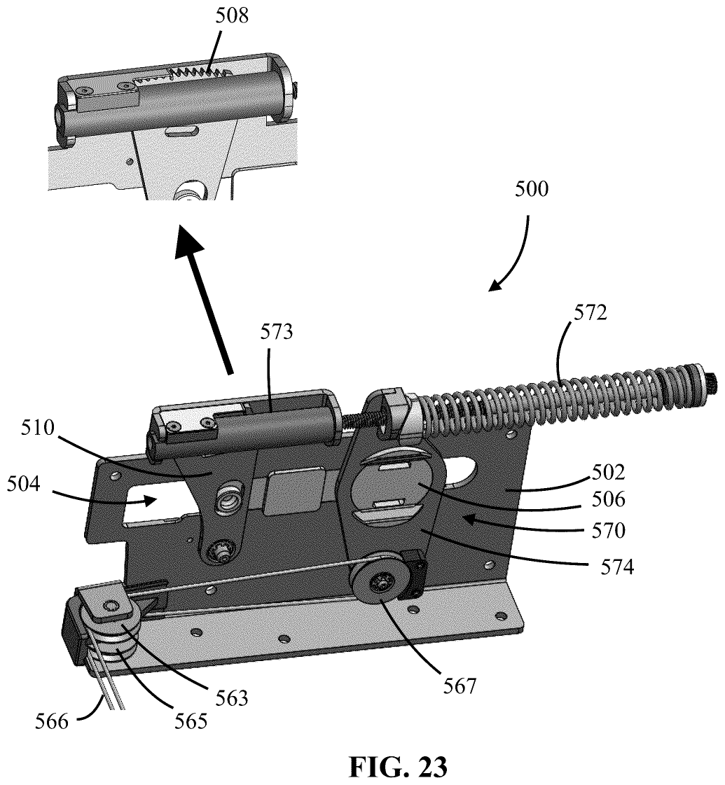

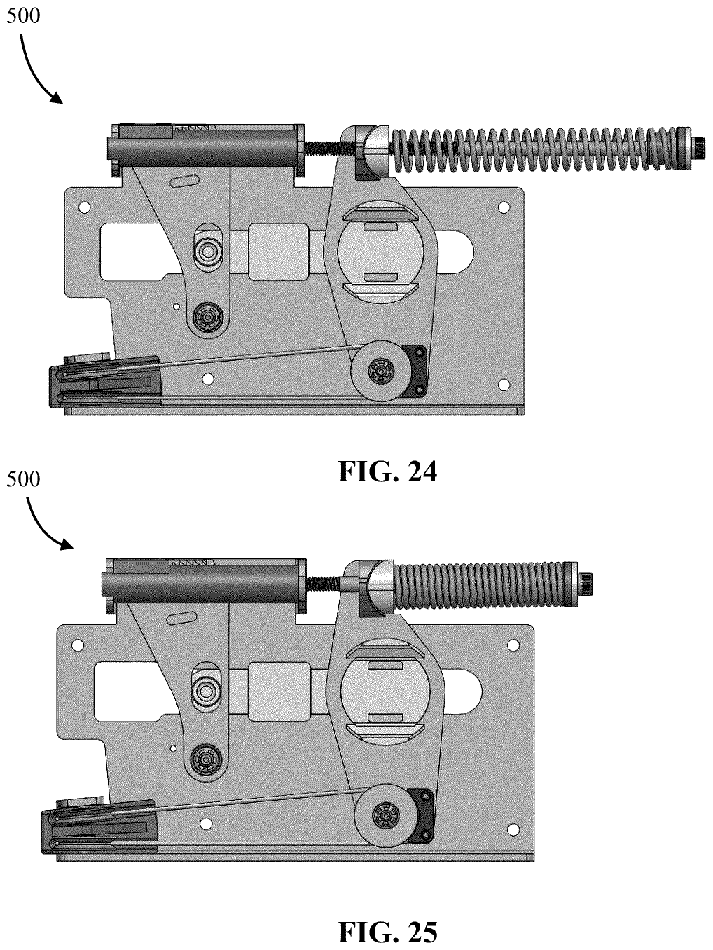

According to another aspect of the disclosure, and with reference to FIGS. 23-25, an alternate embodiment of the first pulley system 64a generally as described above with respect to FIG. 2 is depicted. According to this embodiment, the first pulley system and tensioning system is packaged into an adjustable cable tensioning assembly 500 containing the first pulley 563, second pulley 565, and an adjustable cable tensioning system 570. The adjustable cable tensioning system 570 includes a third tensioning pulley 567 and a tensioning spring 572 operatively connected to each other via a pivot arm 574. The degree of compression of the tensioning spring 572 determines the tension of the cable 566 with a compressed tensioning spring 572 (FIG. 25) used to maintain tension in the cable 566 during use and an uncompressed tensioning spring 572 (FIG. 24) allowing for slack in the cable for installation and maintenance. While the tensioning spring 572 itself is preferably adjustable, the adjustable cable tensioning assembly 500 also allows for quick adjustments to the tension of the cable 566 via movement of the pivot arm 574 that contains the third tensioning pulley 567 and the tensioning spring 572. For example, according to this embodiment, the base 502 of the assembly 500 includes a slot 504. Operatively connected to the slot 504 is a traveler 506 that is operable to be adjustably slidable within the slot 504 via a ratcheting mechanism 508 of ratcheting arm 510. The traveler 506 connects the pivot arm 574 to the slot 504. Thus, movement of the traveler 506 via the ratcheting arm 510 moves both the third pulley 567 and tensioning spring 572 with respect to the stationary first pulley 563 and second pulley 565 for quick adjustments in the tension or slack of the cable 566.

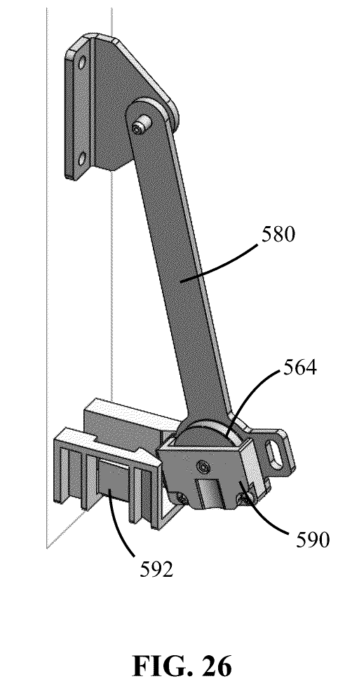

With reference to FIG. 26, and according to another way to quickly adjust tension or slack of the cable during installation or maintenance of the system, the third pulley 564 disposed at the second end of the framed area includes an adjustable position. For example, as shown in FIG. 26, the third pulley 564 is connected to a distal end of a pivot arm 580. The proximal end of the pivot arm 580 is pivotally connected to the appropriate side of the framed area. Thus, to release tension of a cable wound around the third pulley 564, the pulley arm is pivoted upwards towards the first pulley system for a convenient and quick way to introduce slack into the closed loop system. In certain embodiments, the third pulley 564 is positioned within a carriage 590 that is configured to be removably secured to a pulley receiver 592 appropriately positioned along the side of the framed area. Thus, during operation of the system, the third pulley 564 is secured within the pulley receiver 592 via the carriage 590. Then, to introduce slack into the cable system, the third pulley 564 is removed from the pulley receiver 592 via the carriage 590 and then pivoted upwards via the pivot arm 580.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by any claims when interpreted in accordance with the breadth to which they are fairly, legally, and equitably entitled.

What is claimed is:

1. A motorized retractable screen system for a framed area including at least a first side, a second side, a first end, and a second end, the system comprising:
a screen axle configured to be disposed adjacent the first end of the framed area that is operable to be rotated by a motor;
at least one spool operatively connected to the screen axle such that the screen axle and the at least one spool are operable to rotate together;
a screen including a first end operatively connected to the screen axle, a second end operatively connected to a bottom bar, a first side, and a second side, and wherein at least the first side of the screen is formed of a mesh material with a plurality of openings;
a cable including a first end and a second end, wherein the first end is at least partially wound around the at least one spool and the second end is operatively connected to one of the bottom bar and the second of the screen; and
a side edge retention system having a track disposed along a length of at least the first side of the framed area and at least a first brush having a first plurality of brush bristles positioned and configured along a length of the track for engaging the plurality of openings of the mesh material of the first side of the screen during operation of the motorized retractable screen system,
wherein, during operation of the motorized retractable screen system, the screen axle is operable to be rotated in either a first direction or a second direction by the motor such that the cable is operable to pull the bottom bar of the screen between a deployed position and a retracted position while the plurality of brush bristles of the side edge retention system retain the first side of the screen in the track.

2. The motorized retractable screen system of claim 1 further comprising a corner tensioning system including a tensioning arm having a first end configured to be operatively connected to a corner of the first side of the screen, a second end operatively connected to the bottom bar, and a biasing mechanism for biasing the first end of the tensioning arm laterally outward towards the first side of the screen.

3. The motorized retractable screen system of claim 2 wherein the corner of the first side of the screen includes a stirrup configured to receive the first end of the tensioning arm for operatively connecting the first end of the tensioning arm to the corner of the first side of the screen.

4. The motorized retractable screen system of claim 2 wherein the second end of the cable is secured adjacent to the second end of the screen such that the first end of the tensioning arm maintains a lateral force on the corner of the first side of the screen while the cable applies an independent downward force to the screen during operation of the motorized retractable screen system.

5. The motorized retractable screen system of claim 1 wherein the side edge retention system includes a second brush having a second plurality of brush bristles positioned and configured to oppose the first plurality of brush bristles of the first brush for receiving the first side of the screen between the first and second brush for retaining the first side of the screen in the track.

6. The motorized retractable screen system of claim 5 wherein ends of the first plurality of brush bristles are positioned and configured to overlap with ends of the second plurality of brush bristles.

7. The motorized retractable screen system of claim 6 wherein the first and second plurality of brush bristles are positioned and configured with respect to the track to be angled towards the first side of the framed area.

8. The motorized retractable screen system of claim 1 wherein the track includes a first end and a second end that is positioned opposite the first end, and wherein the side edge retention system further includes a second brush having a second plurality of brush bristles, and wherein the first brush is secured to the first end of the track and the second brush is secured to the second end of the track such that ends of the first plurality of brush bristles are positioned and configured to overlap with ends of the second plurality of brush bristles for receiving the first side of the screen between the overlapping first and second plurality of brush bristles.

9. The motorized retractable screen system of claim 8 wherein the first end of the track is dimensioned and configured to receive a plurality of first brushes and the second end of the track is dimensioned and configured to receive a plurality of second brushes for forming a plurality of opposing brush pairs.

10. The motorized retractable screen system of claim 1 wherein the first side of the screen includes a reinforced side edge for enhancing engagement between the first plurality of brush bristles and the plurality of openings of the mesh material of the first side of the screen.

11. The motorized retractable screen system of claim 10 wherein the screen includes a stiffening fiber woven through the plurality of openings of the mesh material.

12. A motorized retractable screen system for a framed area including at least a first side, a second side, a first end, and a second end, the system comprising:
a screen axle configured to be disposed adjacent the first end of the framed area that is operable to be rotated by a motor;
at least one spool operatively connected to the screen axle such that the screen axle and the at least one spool are operable to rotate together;
a screen including a first end operatively connected to the screen axle, a second end operatively connected to a bottom bar, a first side, and a second side;
a cable including a first end and a second end, wherein the first end is at least partially wound around the at least one spool and the second end is operatively connected to the second of the screen; and
a corner tensioning system including a tensioning arm having a first end configured to be operatively connected to a corner of the first side of the screen, a second end operatively connected to the bottom bar, and a biasing mechanism for biasing the first end of the tensioning arm laterally outward towards the first side of the screen,
wherein, during operation of the motorized retractable screen system, the screen axle is operable to be rotated in either a first direction or a second direction by the motor such that the cable is operable to pull the bottom bar of the screen between a deployed position and a retracted position while the first end of the tensioning arm maintains an independent lateral force on the corner of the first side of the screen.

13. The motorized retractable screen system of claim 12 wherein the corner of the first side of the screen includes a stirrup configured to receive the first end of the tensioning arm for operatively connecting the first end of the tensioning arm to the corner of the first side of the screen.

14. The motorized retractable screen system of claim 13 wherein the stirrup is disposed above a connection point in which the second end of the cable is operatively connected to the second end of the screen and the tensioning arm includes a jogged arm shape such that the first end of the tensioning arm is configured to be disposed in the stirrup while a base portion of the tensioning arm is configured to be substantially laterally aligned with the connection point.

15. The motorized retractable screen system of claim 12 wherein the corner tensioning system further includes a housing configured to be restrained within the bottom bar, the tensioning arm being operatively connected to the housing such that the tensioning arm is opereable to move laterally outward with respect to the housing and the bottom bar.

16. The motorized retractable screen system of claim 15 wherein the corner tensioning system is configured to receive a locking mechanism that engages with the tensioning arm to selectively lock the tensioning arm in place with respect to the housing.

17. The motorized retractable screen system of claim 12 wherein the corner tensioning system includes a spring adjustment mechanism for independently adjusting the compression strength of the biasing mechanism, the spring adjustment mechanism having means for adjusting the compression strength of the biasing mechanism while the biasing mechanism is disposed within the bottom bar.

18. A motorized retractable screen system for a framed area including at least a first side, a second side, a first end, and a second end, the system comprising:
a screen axle configured to be disposed adjacent the first end of the framed area that is operable to be rotated by a motor;
at least one spool operatively connected to the screen axle such that the screen axle and the at least one spool are operable to rotate together;
a screen including a first end operatively connected to the screen axle, a second end operatively connected to a bottom bar, a first side, and a second side, and wherein at least the first side of the screen is formed of a mesh material with a plurality of openings;
a cable including a first end and a second end, wherein the first end is at least partially wound around the at least one spool and the second end is operatively connected to one of the bottom bar and the second of the screen;
a side edge retention system having a track disposed along a length of at least the first side of the framed area, the track including a first end and a second end that is positioned opposite the first end, the side edge retention system further including a first brush having a first plurality of brush bristles attached to the first end of the track and a second brush having a second plurality of brush bristles attached to the second end of the track for engaging the plurality of openings of the mesh material of the first side of the screen between the first plurality of brush bristles and the second plurality of brush bristles during operation of the motorized retractable screen system; and
a corner tensioning system including a tensioning arm having a first end configured to be operatively connected to a corner of the first side of the screen, a second end configured to be operatively connected to the bottom bar, and a biasing mechanism for biasing the first end of the tensioning arm laterally outward towards the first side of the screen,
wherein, during operation of the motorized retractable screen system, the screen axle is operable to be rotated in either a first direction or a second direction by the motor such that the cable is operable to pull the bottom bar of the screen between a deployed position and a retracted position while the side edge retention system and corner tensioning system maintain tension of the screen.

19. The motorized retractable screen system of claim 18 wherein the second end of the cable is secured adjacent to the second end of the screen such that the first end of the tensioning arm maintains a lateral force on the corner of the first side of the screen while the cable applies an independent downward force to the screen during operation of the motorized retractable screen system.

20. The motorized retractable screen system of claim 18 wherein the first side of the screen includes a reinforced side edge for enhancing engagement between the first and second plurality of brush bristles and the plurality of openings of the mesh material of the first side of the screen.
